(19) United States
(12) Patent Application Publication
(10) Pub. No.: US 2024/0429782 A1
(43) Pub. Date: Dec. 26, 2024

(54) MOTOR ARRANGEMENT FOR A SHAPING DEVICE, MOTOR FOR A SHAPING DEVICE, HOLDING BODY, SHAPING DEVICE, USE OF A MOTOR AND A HOLDING BODY, AND METHOD FOR COOLING A MOTOR

(71) Applicant: Thomas MEISTER, Michelstadt (DE)

(72) Inventor: Thomas MEISTER, Michelstadt (DE)

(21) Appl. No.: 18/710,215

(22) PCT Filed: Nov. 18, 2022
(86) PCT No.: PCT/DE2022/100865

§ 371 Date: May 15, 2024

(30) Foreign Application Priority Data
Nov. 22, 2021 (DE) 10 2021 130 503.9

(51) Int. Cl. H02K 9/00; H02K 7/06; H02K 7/08

(52) U.S. Cl. CPC H02K 9/00; H02K 7/06; H02K 7/08

(57) ABSTRACT

A motor arrangement is for a moulding device. The motor arrangement has: at least one motor; at least one holding body for holding the at least one motor, the at least one holding body having at least one first recess within which the at least one motor is at least partially received; and at least one duct system, through which a coolant is configured to flow and which is at least partially arranged within the at least one holding body, for dissipating heat from the at least one motor. The at least one duct system has at least one cooling section, which is formed at least in some areas by at least one specific surface of the at least one motor and at least one specific surface of the first recess.

### TECHNICAL FIELD

The present invention relates to a motor arrangement for a moulding device, a motor for a moulding device, a holding body, a moulding device, and uses of the motor and the holding body. The present invention also relates to a method for cooling a motor.

### BACKGROUND ART

In moulding devices for injection moulding of plastic material, hydraulic motor systems, hydraulic cylinders or pneumatically driven systems are typically used to generate rotational or translational movements. However, such systems often cannot be controlled with the desired accuracy and the required forces at high speeds. Furthermore, their use is usually not possible under clean room conditions.

In contrast, electric motors, for example, are generally easy to control and can also be used under clean room conditions. However, high motor currents are necessary to achieve the required torques as well as short acceleration times and high speeds. The associated high heat development can lead to a drop in motor performance or even permanent damage, which can result in a complete production shutdown. Furthermore, high temperatures prevail in moulding devices for injection moulding plastic material, which can result in additional heating of the motors. Especially when electric motors are used in the immediate vicinity of melt-carrying and additionally heated components, such as hot duct systems, heat input is a major problem. Electric motors are used there, for example, for the translational adjustment of closing needles on hot duct nozzles and must be protected against heat input from the heated hot duct system by means of complex cooling systems and thermal separations.

If the electric motors are actively cooled, the additional components required for cooling make it more difficult to install the motors within the device. This increases the complexity of the device and, as a result, its susceptibility to faults.

### SUMMARY OF THE INVENTION

It is therefore an objective of the present invention to overcome the described disadvantages of the state of the art and, in particular, to provide means by which electric motors can be operated continuously yet safely and reliably at high torques and speeds, even under clean room conditions, while at the same time making the electric motors compact.

The problem is solved by the invention according to a first aspect in that a motor arrangement for a moulding device is proposed, wherein the arrangement comprises at least one motor and at least one holding body for holding the motor, wherein the holding body comprises at least one first recess within which the motor is at least partially received; and wherein the arrangement comprises at least one duct system, through which a coolant can flow and which is at least partially arranged within the holding body, for dissipating heat from the motor, wherein the duct system comprises at least one cooling section which is formed at least in some areas by at least one specific surface of the motor and at least one specific surface of the first recess.

The invention is thus based on the surprising finding that a particularly effective cooling of the motor with a simultaneously particularly compact design is possible by the motor itself forming part of a duct system through which a coolant can flow. In this way, the motor can be brought into direct contact with the coolant at the specific surface within the cooling section, which enables particularly good heat transfer from the motor to the coolant and, correspondingly, particularly effective dissipation of heat from the motor. The cooling section is therefore advantageously particularly suitable for dissipating heat from the motor.

In that the duct system is also laid out entirely or partially within the holding body, and thus runs in particular within the holding body, the coolant can preferably be fed to the cooling section from within the holding body. This advantageously means that, at least in the area of the motor, no flow lines extending outside the holding body are required for supplying and removing the coolant of an active cooling system or its attachments. As the motor is therefore not restricted, hindered or even jeopardized by such elements, the operation of the motor and thus of the entire device in which the arrangement is used is much safer and more reliable. The accessibility of the motor, for example for maintenance purposes, is also considerably improved as a result. Since, in contrast to hydraulic systems, the arrangement does not require any oil or similar substances for operation, it is also possible for the arrangement to be suitable for clean rooms.

Preferably, the motor is arranged within the first recess in such a way that the coolant entering the cooling section at at least one inlet opening flows around the specific surface of the motor and/or leaves the cooling section again at at least one outlet opening, preferably opposite the inlet opening. As the inlet opening and the outlet opening are opposite each other, a reliable flow around the specific surface of the motor can be achieved.

The particularly effective cooling also means that the surroundings are not heated or only heated to a lesser extent. This can reduce power losses in the motor or neighboring electrical components and prevent damage to them. The efficient cooling also has the additional advantage that the motor can be operated at a higher current and therefore at a higher power. Active cooling also means that the pause times required to cool the motor between individual injection moulding cycles can be significantly reduced or even completely eliminated. This makes it possible to set shorter and, in particular, continuous process cycles. As a result, the productivity of the injection moulding process can be significantly increased.

As the motor itself, apart from the specific surface, advantageously does not have to provide any components for active motor cooling, the motor can also be designed to be particularly compact. This makes it even easier to fully integrate the motor into the arrangement and thus into the respective device. Furthermore, the motor can also be easily installed within the respective device, which has not been possible conventionally due to the large dimensions of actively cooled motors.

In addition, the distances between neighboring motors can also be reduced. As a result, motor arrangements with active cooling that could not previously be realized in terms of compactness are possible with the proposed arrangement. The distance between neighboring motors is then advantageously determined essentially by the dimensions of the motors themselves.

The first recess also allows the motor to be arranged particularly easily and securely within the arrangement. The motor can advantageously be simply pushed into the first recess. Furthermore, no screws are required, for example, to arrange the motor on the holding body. This facilitates maintenance and replacement of the motor.

The compactness is further promoted by the fact that the duct system is also arranged wholly or partially within the holding body. For example, the duct system can be formed integrally through and/or within the holding body, at least in some areas. As a result, the duct system can be positioned inside the holding body when manufacturing the holding body. This enables favorable manufacturing.

Since the motor itself advantageously does not have to provide any further cooling components, many conventional motors without integrated cooling can also be easily used in the proposed arrangement and can be actively cooled in this way. Therefore, existing devices can also be easily and particularly economically retrofitted with the proposed arrangement.

The proposed arrangement thus enables active cooling of the motor to be realized in a particularly simple yet extremely efficient, compact, reliable and cost-effective manner. As a result, the efficiency and performance of the motor can be increased. In this way, continuous, short injection moulding cycles are possible without additional pause times. The proposed motor arrangement can therefore be understood as a motor mount with an integrated cooling option for the motor.

The proposed motor arrangement is advantageously arranged within the moulding device. The moulding device can for example be a moulding device for injection moulding plastic material, such as an injection moulding tool.

The first recess extends along its axial direction, preferably parallel to the axial direction of extension of the motor.

The holding body preferably has at least one coolant inlet and at least one coolant outlet of the duct system. These can optionally be connected to a coolant circuit. The duct system can, for example, form or represent a flow line for the coolant.

The duct system therefore advantageously enables heat to be dissipated from the motor, in particular by heat being dissipated or it being possible for heat to be dissipated from the motor during operation of the arrangement by means of the coolant flowing through the duct system.

The cooling section is preferably a section of the duct system within which the coolant flowing through the duct system during operation of the arrangement can be brought into direct contact with the motor, in particular the specific surface of the motor, at least in some areas.

The axial extension of the first recess is preferably 40 mm or more, 100 mm or less and/or between 40 mm and 100 mm. The axial extension of the first recess can be 56 mm, for example.

The diameter of the coolant inlet is preferably 2 mm or more, 30 mm or less and/or between 2 mm and 30 mm. The diameter of the coolant inlet can be 8 mm, for example.

The diameter of the coolant outlet is preferably 2 mm or more, 30 mm or less and/or between 2 mm and 30 mm. The diameter of the coolant outlet can be 8 mm, for example.

The flow cross-section of the duct system arranged within the holding body preferably has a diameter of 2 mm or more, 30 mm or less and/or between 2 mm and 30 mm. The flow cross-section of the duct system arranged within the holding body can, for example, have a diameter of 8 mm.

Alternatively or additionally, it can also be provided that the holding body is parallelepiped-shaped, in particular plate-shaped.

Preferably, the holding body is solid, at least in some areas. This can improve the stability of the arrangement.

The holding body can be screwed onto a hot duct manifold, especially if it is parallelepiped-shaped. Optionally, the holding body can be formed by such a hot duct manifold.

The holding body preferably has three main directions of extension, all of which are perpendicular to each other.

Preferably, a holding body is plate-shaped if the holding body has an extension along two of its main directions of extension that is two times or more than two times, preferably three times or more than three times, preferably five times or more than five times, preferably ten times or more than ten times, greater than an extension of the holding body along a third main direction of extension, which preferably runs parallel to the main direction of extension of the first recess.

Alternatively or additionally, it can also be provided that the first recess is cylindrical at least in some areas and/or completely penetrates the holding body along a main direction of extension, in particular a thickness range, of the holding body.

A cylindrical recess is particularly easy to incorporate into the holding body.

The thickness range can, for example, run along a main direction of extension of the holding body. Preferably, the holding body has a smaller extension along the thickness area than along the other two main directions of extension of the main body.

The thickness range of the holding body can, for example, run along the main direction of extension of the holding body along which the holding body has the smallest extension.

Alternatively or additionally, it can also be provided that the specific surface of the motor is strip-shaped at least in some areas and/or is at least one outer surface area of a housing of the motor, and wherein preferably the motor housing is cylindrical at least in the area of the specific surface.

By selecting an outer surface of a housing of the motor as the specific surface of the motor, the heat can be dissipated directly from the motor in a particularly reliable manner. The housing reliably prevents electrical components of the motor from coming into contact with the coolant. As a result, the cooling is also particularly advantageous from a safety point of view.

Preferably, the motor housing is an external motor housing.

The cylindrical design of the housing supports a uniform and reliable flow of the coolant around the surface of the housing within the cooling section. In addition, the cylindrical housing can interact particularly well with the cylindrical first recess. This allows positive cooling properties to be combined with particularly simple manufacture.

In particular, the motor housing no longer has to be rectangular, as is conventionally the case, in order to allow screws to be attached in the four corners of the rectangular shape, due to the particularly simple option of being able to arrange the motor within the first recess without screws, as already mentioned above.

Preferably, the specific surface of the motor is cylindrical, at least in some areas.

The axial extension of the housing is preferably 30 mm or more, 100 mm or less and/or between 30 mm and 100 mm. The axial extension of the housing can be 56 mm, for example.

The motor housing preferably comprises or consists of a metal, in particular aluminum, brass, steel, in particular stainless steel, magnesium and/or an alloy and/or powder-metallurgical combinations of the aforementioned materials, at least in some areas.

Alternatively or additionally, it can also be provided that the duct system is formed at least in sections by cavities extending within the holding body.

For example, the holding body can be solid and the first recess and/or the duct system is provided within the solid body. For example, the duct system and/or at least one initial recess can be introduced or can be introducible into the holding body at least in some areas by milling, by drilling, by laser and/or a combination thereof.

Alternatively or additionally, it can also be provided that the cooling section is fluidly connected to the remaining duct system via at least two openings, in particular at two location within the first recess and/or at two diametrically opposed locations within the first recess, preferably with more than two openings.

By providing the openings within the first recess, the cooling section is particularly simple and can also be fluidly connected to the rest of the duct system within the holding body. The arrangement can thus be particularly compact.

In particular, the sections of the duct system that are fluidly connected or connectable to the cooling section can thus also run at least in sections within the holding body. This makes it possible to avoid having to provide parts of the duct system such as flow lines, fastenings or suchlike outside the holding body, which could restrict, disrupt or jeopardize the operation of the engine. In this way, the operation of the motor and the entire arrangement can be made particularly safe.

The diameter of the openings is preferably 2 mm or more, 30 mm or less and/or between 2 mm and 30 mm. The diameter of the openings can be 8 mm, for example.

Alternatively or additionally, it can also be provided that the cooling section, preferably within a cross-sectional plane, extending in particular perpendicularly to the centre axis of the first recess and/or perpendicularly to the motor axis, is ring-shaped at least in some areas.

This can be easily realized, for example, if the specific surfaces of the motor and first recess are each cylindrical in shape, at least in some areas, and are arranged coaxially and at least in some areas, in particular radially, at a distance from each other.

As a result, the cooling section through which the coolant can flow can therefore advantageously be cylindrical in shape, at least in some areas.

Alternatively or additionally, it can also be provided that the specific surface of the first recess is strip-shaped at least in some areas, is at least one surface area of the first recess and/or is arranged at a distance from the specific surface of the motor at least in some areas and/or along at least one circumferential direction of the surface of the first recess.

By arranging the two specific surfaces at a corresponding distance from each other, the cooling section can be reliably formed.

Preferably, the specific surfaces are radially spaced apart from one another and/or lie opposite one another, at least in some areas.

Alternatively or additionally, it can also be provided that the specific surface of the first recess and the specific surface of the motor are designed and/or arranged relative to each other in such a way that they form, at least in some areas, a duct as at least one part of the cooling section, through which duct the coolant can flow.

The specific surfaces are therefore matched to each other to form a duct through which the coolant can flow. This means that the cooling section can be formed particularly reliably.

Alternatively or additionally, it can also be provided that the first recess comprises at least two gradations, by which the cooling section is at least in some areas limited along the two axial directions of the first recess.

This makes it particularly easy to limit the cooling section laterally, i.e. in particular towards the edges of the first recess. For example, the specific surface of the motor, i.e. in particular the corresponding surface of the motor housing, then has no gradation.

In one embodiment, the gradations are each rotationally symmetrical.

Preferably, a first recess section with a first inner diameter, a second recess section with a second inner diameter and a third recess section with a third inner diameter follow one another along an axial direction, wherein the first gradation forms a transition between the first and second recess sections and the second gradation forms a transition between the second and third recess sections, and wherein preferably the first and third inner diameters are the same and/or the first and/or third inner diameters are each smaller than the second inner diameter.

The first and/or third inner diameter is preferably 30 mm or more, 100 mm or less and/or between 30 mm and 100 mm. The first and/or third inner diameter can be 55 mm, for example.

The second inner diameter is preferably 30 mm or more, 100 mm or less and/or between 30 mm and 100 mm. The second inner diameter can be 58 mm, for example.

When the present application refers to a gradation, this is preferably understood to mean a means for at least partially and/or at least in some areas forming the cooling section and/or limiting the cooling section in at least one axial direction.

When reference is made in the present application to an axial direction, this is preferably understood to mean a direction which runs parallel to a main direction of extension of the first recess, parallel to a centre axis of the first recess and/or parallel to a centre axis of the motor. There is therefore a first axial direction and a second axial direction running antiparallel to it.

Alternatively or additionally, it can also be provided that the motor housing comprises at least two gradations, by which the cooling section is at least in some areas limited along the two axial directions of the first recess.

This makes it particularly easy to limit the cooling section laterally, i.e. towards the edges of the first recess.

Preferably, the specific surface of the first recess then has no gradation.

In one embodiment, the gradations are each rotationally symmetrical.

Preferably, a first housing section with a first outer diameter, a second housing section with a second outer diameter and a third housing section with a third outer diameter follow one another along an axial direction, wherein the first gradation forms a transition between the first and second housing sections and the second gradation forms a transition between the second and third housing sections, and wherein preferably the first and third outer diameters are the same and/or the first and/or third outer diameter is or are each greater than the second outer diameter.

The first and/or third outer diameter is preferably 30 mm or more, 100 mm or less and/or between 30 mm and 100 mm. The first and/or third outer diameter can be 58 mm, for example.

The second outer diameter is preferably 30 mm or more, 100 mm or less and/or between 30 mm and 100 mm. The second outer diameter can be 55 mm, for example.

Alternatively or additionally, it can also be provided that the first recess comprises at least one gradation and the motor housing comprises at least one gradation, by which gradations the cooling section is at least in some areas limited along the two axial directions of the first recess.

This makes it particularly easy to limit the cooling section laterally, i.e. towards the edges of the first recess, by interaction between the first recess and the motor housing.

In one embodiment, the gradations are each rotationally symmetrical.

Preferably, (a) at least one first recess section with a first inner diameter and at least one second recess section with a second inner diameter follow one another along an axial direction, wherein the gradation of the first recess forms a transition between the first and second recess sections, and (b) at least one first housing section with a first outer diameter and at least one second housing section with a second outer diameter follow one another along an axial direction, wherein the gradation of the motor housing forms a transition between the first and second housing sections, and wherein preferably (i) the first inner diameter is smaller than the second inner diameter and/or the first outer diameter is smaller than the second outer diameter and/or (ii) the first recess section is in contact at least in some areas with at least regions of the first housing section and/or the second recess section is in contact at least in some areas with at least regions of the second housing section.

Thus, the cooling section can be formed advantageously at least in some areas in the axial direction between the two contact ranges.

The axial extension of the second housing section is preferably 5 mm or more, 50 mm or less and/or between 5 mm and 50 mm. The axial extension of the second housing section can be 12 mm, for example.

The axial extension of the first housing section is preferably 30 mm or more, 100 mm or less and/or between 30 mm and 100 mm. The axial extension of the first housing section can be 55 mm, for example.

The first inner diameter of the first recess section is preferably 30 mm or more, 100 mm or less and/or between 30 mm and 100 mm. The first inner diameter of the first recess section can be 55 mm, for example.

The second inner diameter of the second recess section is preferably 30 mm or more, 100 mm or less and/or between 30 mm and 100 mm. The second inner diameter of the second recess section can be 58 mm, for example.

The first outer diameter of the first housing section is preferably 30 mm or more, 100 mm or less and/or between 30 mm and 100 mm. The first outer diameter of the first housing section can be 55 mm, for example.

The second outer diameter of the second housing section is preferably 30 mm or more, 100 mm or less and/or between 30 mm and 100 mm. The second outer diameter of the second housing section can be 58 mm, for example.

In one embodiment, the first inner diameter and the first outer diameter and/or the second inner diameter and the second outer diameter are each identical.

Alternatively or additionally, it can also be provided that at least one sealing element, preferably at least two sealing elements, for sealing the cooling section towards the outside, in particular towards one or both outer edges of the first recess, is or are arranged inside the first recess.

As a result, leakage in the area of the first recess can be avoided particularly reliably.

Alternatively or additionally, it can also be provided that the sealing elements are each designed in the form of an O-ring and preferably each sealing element is accommodated within a respective ring groove of the motor, in particular of the motor housing.

By arranging the sealing elements on the motor, they can be reliably arranged in the correct position with the arrangement of the motor within the first recess. This facilitates the use of the arrangement and increases safety.

For example, the ring grooves can each be provided in an axial end region of the motor, in particular the motor housing.

Alternatively or additionally, it can also be provided that the motor, in particular the housing of the motor, is supported on at least one support element of the arrangement to limit the displaceability of the motor along an axial direction within the first recess.

The axial freedom of movement can be restricted by the support element, for example by preventing the motor from moving along an axial direction. This allows the motor to be securely arranged in the first recess.

Alternatively or additionally, it can also be provided that the support element is provided in the form of a shoulder surface of at least one locking body of the arrangement which locking body is arranged laterally at the holding body, wherein preferably the locking body comprises at least one cylindrical second recess, in particular penetrating the locking body along a main direction of extension, in particular a thickness range, of the locking body, wherein the first recess and the second recess are aligned coaxially to one another and wherein the facing outer edges of the first and second recess have diameters and the diameter of the edge of the second recess is smaller than the diameter of the edge of the first recess, and preferably the shoulder surface is formed thereby.

Preferably, the first and second recesses enclose a contiguous volume.

The axial extension of the second recess is preferably 5 mm or more, 60 mm or less and/or between 5 mm and 60 mm. The axial extension of the second recess can be 27 mm or 30 mm, for example.

The inner diameter of the second recess is preferably 30 mm or more, 100 mm or less and/or between 30 mm and 100 mm. The inner diameter of the second recess can be 54 mm or 50 mm, for example.

Alternatively or additionally, it can also be provided that the motor, in particular the housing of the motor, is supported on at least two support elements of the arrangement for fixing the axial position of the motor along an axial direction within the first recess, wherein preferably both support elements are provided in the form of shoulder surfaces of at least two locking bodies of the arrangement arranged on two opposite sides of the holding body at the holding body with second recesses adapted to the respective diameters of the outer edges of the first recess.

Advantageously, both locking bodies are identical. This makes a simple setting up of the arrangement possible.

Alternatively or additionally, it can also be provided that the holding body is connected to at least one or exactly one of the locking bodies in such a way so that the holding body can be detached again without being destroyed.

This makes it particularly easy to arrange the motor within the first recess and also to remove it from the same. This makes maintenance or replacement of a motor very quick and also easy.

For example, the holding body and locking body can be screwed together.

Alternatively or additionally, it can also be provided that the holding body and/or the at least one locking body comprises or consists of metal, in particular aluminum, steel, in particular stainless steel, brass and/or an alloy and/or powder-metallurgical combinations of the aforementioned materials.

If two locking bodies are provided, the choice of material for each of the two locking bodies is preferably selected individually as proposed.

Alternatively or additionally, it can also be provided that the motor is an electric motor, such as a servomotor, in particular in the form of a linear actuator for generating translatory movements.

A servomotor can be controlled particularly reliably. Preferably, the servomotor is of the brushless rotary type and/or has an encoder or a resolver as a position sensor system.

The servomotor is preferably designed as a linear actuator for generating translatory movements. The servomotor is advantageously designed alternatively or additionally to generate rotary movements.

The axial extension of the motor is preferably 30 mm or more, 200 mm or less and/or between 30 mm and 200 mm. The axial extension of the motor can be 89.4 mm, for example.

Alternatively or additionally, it can also be provided that the motor comprises at least one bearing cover for closing off at least one end of the motor, wherein preferably (a) the bearing cover comprises at least one external thread at least in some areas and the bearing cover is screwed or can be screwed into the motor housing by means of the external thread and/or (b) the motor furthermore comprises at least one threaded ring for fastening the bearing cover of the motor to the motor housing and/or comprises at least one spindle system for converting a rotary movement into a linear movement of the motor.

If the motor has a threaded ring, the respective bearing cover is preferably also attached to the motor housing.

Advantageously, the motor has two bearing covers for closing off both ends of the motor. It can be individually selected for each of the bearing covers whether it is preferably equipped with an external thread or is attached to the motor by a threaded ring.

Motors, such as electric motors, in particular servomotors, with a spindle system installed inside the motor for converting the rotary movement into a linear movement, enable the motor to perform translatory movements particularly reliably and quickly.

The frictional heat generated during operation of the spindle system can be dissipated particularly well with the proposed arrangement. As a result, the heating of the motor can be reduced. The service life of the spindle system can be increased in this way and the functionality of the motor guaranteed in the long term.

Therefore, such motors with a spindle system are particularly preferable for use in the proposed arrangement in order to be able to reliably perform continuous and fast translational movements.

The spindle system optionally has a spindle nut and a spindle.

Alternatively or additionally, it can also be provided that a rotor of the motor is positioned at its end portions within the housing of the motor by means of at least two ball bearings, and wherein preferably
the one ball bearing, in particular an outer collar of the ball bearing, is supported against one of the bearing covers of the motor, which bearing cover is preferably (a) fixed by the threaded ring screwed into the housing, (b) screwed into the motor housing and/or (c) closes off the motor on the underside, and/or
the other ball bearing, in particular an outer collar of the other ball bearing, is supported against another of the bearing covers of the motor, which other bearing cover is preferably (a) fixed by the threaded ring screwed into the housing, (b) screwed into the motor housing and/or (c) closes off the motor at the top.

This is particularly advantageous in order to reliably absorb high axial forces, such as those resulting from the use of a spindle system, while still maintaining a compact design.

The bearing cover can be at least in some areas ring-shaped, for example.

The ball bearings are preferably designed as angular contact ball bearings. This means that any axial forces that occur, particularly in connection with the spindle system, can be absorbed particularly well and reliably.

It has proved advantageous if the motor has one or more of the following features as an alternative or in addition:
Preferably, the motor is designed as a servomotor, has it and/or represents it.
Preferably, the motor has at least one housing. In particular, the housing is at least in some areas cylindrical in shape.
Preferably, the motor has at least one rotor.
Preferably, the motor has one or more than one, in particular two, ball bearings, in particular angular contact ball bearings.
The rotor can, for example, be positioned by at least two of the ball bearings, in particular within the motor. For this purpose, a first ball bearing of the at least two ball bearings can be installed in the housing and a second ball bearing of the at least two ball bearings can be installed in a first bearing cover of the motor.
Preferably, an outer collar of the first ball bearing is supported against a second bearing cover of the motor.
Preferably, the second bearing cover closes off the motor on one side, in particular on its underside, and/or is fixed by a threaded ring that can be screwed into the motor housing.
Preferably, the first bearing cover closes off the motor on one side, in particular on its upper side, and/or is fixed in place by a threaded ring that can be screwed into the motor housing.
Thanks to the two threaded rings, it is advantageous that no screws are required to fasten the first and second bearing covers. The motor is then also preferably particularly easy to design with a cylindrical housing, as the housing is no longer part of the fastening means.
Preferably, the rotor is fixed and axially braced, in particular at the lower end, by means of a threaded ring with an inner collar of the first ball bearing and/or, in particular at the upper end, by means of a threaded ring with an inner collar of the second ball bearing.
Preferably, the rotor has a large number of flattenings, in particular lateral flattenings, in particular along a circumferential direction. Magnets of the motor are or can be laid out on the flattenings. The motor preferably has magnets that are arranged, in particular glued, to the flattenings.
Preferably, the rotor, in particular at the upper end, has a spigot-shaped extension for accommodating a position sensor system provided by the motor and preferably enclosed by a cover. In particular, the motor has such a position sensor system and this is accommodated by the spigot-shaped extension. In addition, the cover can advantageously have a lateral opening. Cables of the position sensor system and/or cables of windings of the motor molded into the housing can advantageously be guided outwards through this opening.
Preferably, the motor has a spindle system that is used or can be used inside the rotor. The spindle system can, for example, take the form of a linear spindle. The spindle system preferably has a spindle and a spindle nut. Preferably, a movement thread is arranged on the outer circumference of the spindle, at least in some areas, in particular partially towards the upper end. Preferably, the spindle has a fastening thread, particularly at the lower end. Optionally, the fastening thread is followed by a flattening in the axial direction. This flattening enables the spindle to be locked in a known manner to prevent the spindle from rotating together with the spindle nut. The locking mechanism can, for example, be provided on the component to be moved, such as a closing needle of the hot duct system. Preferably, the spindle is guided coaxially within the motor with a sliding bush and/or sealed via a seal.
Preferably, the rotor has at least one cavity for accommodating a spindle system, such as the spindle system described above, and/or the rotor is hollow, at least in some areas, in the form of a sleeve-shaped part and/or as a cavity. Due to the special design of the rotor as a sleeve-shaped part, the spindle system, in particular in the form of a linear spindle, can be easily inserted into the interior of the rotor and replaced in the event of damage or maintenance work. Different spindle systems can therefore also be inserted into the rotor in order to either build more cost-effective variants or achieve higher thrust forces.
Preferably, the rotor has an insertion on its inside in which a tolerance sleeve is arranged and which connects the spindle nut to the rotor in a force-locking manner via a clamping effect.
Preferably, during operation of the motor, in particular the servomotor, the spindle nut can be set in a rotative movement, in particular in phase, by rotation of the rotor, and thereby the spindle is linearly displaceable. The spindle nut and rotor are preferably connected to each other so that they cannot rotate.
Therefore, the motor, in particular the servomotor, is preferably set up so that the spindle nut performs a rotational movement during operation of the motor by rotating the rotor, and thereby the spindle is linearly displaceable.
Preferably, a stop buffer is provided at the upper end of the rotor, in particular inside the motor, which is preferably attached to the rotor by means of a screw. This prevents an unintentional stop in the event of a malfunction and thus prevents the spindle from seizing.
The rotor is preferably designed as a sleeve-shaped part, in particular for at least partially receiving the linear spindle.
Preferably, the second bearing cover has an external thread at least in some areas and/or can be screwed into the housing. Preferably, the second bearing cover holds the first ball bearing.
Preferably, the spindle nut has an insertion on an outer side in which a tolerance sleeve is arranged.

Alternatively or additionally, it can also be provided that the arrangement comprises a plurality of motors and the holding body comprises a plurality of first recesses with the motors at least partially received therein, and wherein preferably the duct system comprises at least two cooling sections formed by the specific surfaces of the first recesses and motors, which cooling sections are preferably arranged at least partially fluidically in series or parallel to one another, for example along a rectilinear main flow direction of the coolant when the arrangement is in use.

As a result, the arrangement can also be used cost-effectively with a large number of motors.

As the duct system runs along a main flow direction, the arrangement is easy to manufacture. For example, several identical partial holding bodies can be arranged in fluidic succession in order to obtain the entire holding body.

For example, the holding body is made up of several identical modules. Preferably, each module has a first recess and/or at least one section of the duct system running perpendicularly to the centre axis of the first recess.

Advantageously, this allows neighboring motors, in particular with a maximum diameter of more than 50 mm, to have a centre distance of less than 100 mm or even less than 80 mm, for example. Optionally, they have a centre distance of at least 50 mm, preferably at least 55 mm, preferably at least 60 mm.

Alternatively or additionally, it can also be provided that the arrangement comprises a plurality of motors and the holding body comprises a plurality of first recesses with the motors at least partially received therein, and wherein the arrangement comprises at least two separate duct systems each with at least one of the cooling sections formed by the specific surfaces of the first recesses and motors.

This allows individual motors or groups of motors to be connected to a separate coolant circuit. For example, motors with particularly high heat generation can be cooled by their own coolant circuit.

Preferably, different coolants, different dimensions of the duct system and/or different flow rates of the coolant can be provided in the individual duct systems. In this way, the arrangement can be specifically oriented to the respective amounts of heat to be dissipated via a duct system.

Alternatively or additionally, it can also be provided that the coolant comprises or consists of a fluid, in particular water, air, oil, at least one liquefied gas, such as hydrogen, nitrogen and/or helium, at least one alcohol and/or a mixture of the aforementioned substances.

These cooling media can be channelled particularly reliably within the duct system. In particular, these cooling media are particularly suitable for flowing within a duct system which is optionally formed by the particularly preferred materials of the holding body.

The problem is solved by the invention according to a second aspect in that a motor for a moulding device is proposed. Preferably, the motor is an electric motor, such as a servomotor, and/or for use in an arrangement according to the first aspect of the invention.

A corresponding motor is particularly well suited to form part of a duct system in such an arrangement, and thus to be cooled within such an arrangement.

Preferably, the motor is adapted for use in an arrangement according to the first aspect of the invention.

All embodiments made in relation to the first aspect of the invention with regard to the motor apply here accordingly and the motor proposed here can in this respect also optionally comprise one or more of the aforementioned features. The explanations need not therefore be repeated here. Nevertheless, at least the following particularly advantageous features should be mentioned again, which, in particular alone or in any combination, can be provided for the motor according to the second aspect of the invention:
Preferably, the motor is designed as a servomotor, has it and/or represents it.
Preferably, the motor has at least one housing. In particular, the housing is at least in some areas cylindrical in shape.
Preferably, the motor has at least one rotor.
Preferably, the motor has one or more than one, in particular two, ball bearings, in particular angular contact ball bearings.
The rotor can for example be positioned by at least two of the ball bearings, in particular within the motor. For this purpose, a first ball bearing of the at least two ball bearings can be installed in the housing and a second ball bearing of the at least two ball bearings can be installed in a first bearing cover of the motor.
Preferably, an outer collar of the first ball bearing is supported against a second bearing cover of the motor.
Preferably, the second bearing cover closes off the motor on one side, in particular on its underside, and/or is fixed by a threaded ring that can be screwed into the motor housing.
Preferably, the first bearing cover closes off the motor on one side, in particular on its upper side, and/or is fixed in place by a threaded ring that can be screwed into the motor housing.
Thanks to the two threaded rings, it is advantageous that no screws are required to fasten the first and second bearing covers. The motor is then also preferably particularly easy to design with a cylindrical housing, as the housing is no longer part of the fastening means.
Preferably, the rotor is fixed and axially braced, in particular at the lower end, by means of a threaded ring with an inner collar of the first ball bearing and/or, in particular at the upper end, by means of a threaded ring with an inner collar of the second ball bearing.
Preferably, the rotor has a large number of flattenings, in particular lateral flattenings, in particular along a circumferential direction. Magnets of the motor are or can be laid out on the flattenings. The motor preferably has magnets that are arranged, in particular glued, to the flattenings.
Preferably, the rotor, in particular at the upper end, has a spigot-shaped extension for accommodating a position sensor system provided by the motor and preferably enclosed by a cover. In particular, the motor has such a position sensor system and this is accommodated by the spigot-shaped extension. In addition, the cover can advantageously have a lateral opening. Cables of the position sensor system and/or cables of windings of the motor molded into the housing can advantageously be guided outwards through this opening.
Preferably, the motor has a spindle system that is used or can be used inside the rotor. The spindle system can, for example, take the form of a linear spindle. The spindle system preferably has a spindle and a spindle nut. Preferably, a movement thread is arranged on the outer circumference of the spindle, at least in some areas, in particular partially towards the upper end. Preferably, the spindle has a fastening thread, particularly at the lower end. Optionally, the fastening thread is followed by a flattening in the axial direction. This flattening enables the spindle to be locked in a known manner to prevent the spindle from rotating together with the spindle nut. The locking mechanism can, for example, be provided on the component to be moved, such as a closing needle of the hot duct system. Preferably, the spindle is guided coaxially within the motor with a sliding bush and/or sealed via a seal.
Preferably, the rotor has at least one cavity for accommodating a spindle system, such as the spindle system described above, and/or the rotor is hollow, at least in some areas, in the form of a sleeve-shaped part and/or a cavity. Due to the special design of the rotor as a sleeve-shaped part, the spindle system, in particular in the form of a linear spindle, can be easily inserted into the interior of the rotor and replaced in the event of damage or maintenance work. Different spindle systems can therefore also be inserted into the rotor in order to either build more cost-effective variants or achieve higher thrust forces.
Preferably, the rotor has a recess on its inside in which a tolerance sleeve is arranged and which connects the spindle nut to the rotor in a force-locking manner via a clamping effect.
Preferably, during operation of the motor, in particular the servomotor, the spindle nut can be set in a rotative movement, in particular in phase, by rotation of the rotor, and thereby the spindle is linearly displaceable. The spindle nut and rotor are preferably connected to each other so that they cannot rotate.
Therefore, the motor, in particular the servomotor, is preferably set up so that the spindle nut performs a rotational movement during operation of the motor by rotating the rotor, and thereby the spindle is linearly displaceable.
Preferably, a stop buffer is provided at the upper end of the rotor, in particular inside the motor, which is preferably attached to the rotor by means of a screw. This prevents an unintentional stop in the event of a malfunction and thus prevents the spindle from seizing.
The rotor is preferably designed as a sleeve-shaped part, in particular for at least partially receiving the linear spindle.
Preferably, the second bearing cover has an external thread at least in some areas and/or can be screwed into the housing. Preferably, the second bearing cover holds the first ball bearing.
Preferably, the spindle nut has a recess on an outer side in which a tolerance sleeve is arranged.

Alternatively or additionally, it can also be provided that the motor comprises at least one, preferably at least in some areas and/or at least sectionally cylindrical, housing, which preferably comprises at least one gradation and/or at two axial end regions in each case a circumferential groove with an O-ring arranged therein in each case.

The problem is solved by the invention according to a third aspect in that a holding body is proposed for holding a motor, in particular a motor of a moulding device and/or according to the second aspect of the invention, for use in an arrangement according to the first aspect of the invention, the holding body comprising at least one recess within which the motor can be at least partially received, and at least one duct system arranged within the holding body and through which a coolant can flow for dissipating heat from the motor, wherein the recess crosses the duct system at least in some areas.

Preferably, the holding body is adapted for use in an arrangement according to the first aspect of the invention.

All the explanations made with regard to the first aspect of the invention with respect to the holding body apply here accordingly and the holding body proposed here can in this respect also optionally have one or more of the aforementioned features. The explanations need not therefore be repeated here.

The recess of the holding body therefore preferably corresponds to a first recess of a holding body of the arrangement according to the first aspect of the invention.

Optionally, at least one locking body arranged on the holding body, in particular in such a way that it can be detached again, can also be provided here. Of course, the explanations made with respect to the first aspect of the invention also apply to the locking body and the interaction between the holding body and the locking body.

Alternatively or additionally, it can also be provided that in the installed state of the motor within the recess, the duct system comprises at least one cooling section which is formed at least in some areas by at least one specific surface of the motor and at least one specific surface of the recess.

The problem is solved by the invention according to a fourth aspect in that a moulding device is proposed, comprising at least one motor arrangement according to the first aspect of the invention, at least one motor according to the second aspect of the invention and/or at least one holding body according to the third aspect of the invention.

All the advantages also described in relation to the first aspect of the invention apply equally to the device. The explanations therefore need not be repeated here.

The shaping device can, for example, be an injection mould.

The problem is solved by the invention according to a fifth aspect in that a use of a motor, in particular an electric motor, such as a servomotor, and/or a motor according to the second aspect of the invention, in an arrangement according to the first aspect of the invention, is proposed.

It has surprisingly been found that the use of such a motor in a corresponding arrangement leads to the advantages described in relation to the first aspect of the invention.

The problem is solved by the invention according to a sixth aspect in that a use of a holding body, in particular a holding body according to the third aspect of the invention, in an arrangement according to the first aspect of the invention, is proposed.

It has surprisingly been found that the use of such a holding body in a corresponding arrangement leads to the advantages described in relation to the first aspect of the invention.

The problem is solved by the invention according to a seventh aspect in that a method for cooling a motor is proposed, in particular a motor of a moulding device, such as the moulding device according to the fourth aspect of the invention, and/or a motor according to the second aspect of the invention, the method comprising:
providing an arrangement according to the first aspect of the invention; and
at least temporarily passing a coolant, in particular comprising or consisting of a fluid, in particular water, air, oil, at least one liquefied gas, such as hydrogen, nitrogen and/or helium, at least one alcohol and/or a mixture of the aforementioned substances, through the at least one duct system of the arrangement, in particular from a coolant inlet to a coolant outlet.

By cooling the motor accordingly, it has been surprisingly found that even short process cycles can be realized. The cooling section represents an interaction zone by means of which the heat can be dissipated from the motor particularly efficiently. For further advantages, reference can be made to the explanations given in relation to the first aspect of the invention.

### BRIEF DESCRIPTION OF THE DRAWINGS

Further features and advantages of the invention can be seen from the following description, in which preferred embodiments of the invention are explained with reference to schematic drawings. The following is shown here:

FIG. 1a a perspective partially sectioned view of an arrangement according to the first aspect of the invention in a first embodiment;

FIG. 1b a perspective sectional view of the arrangement of FIG. 1a with reduced details;

FIG. 1c a sectional view of the arrangement of FIG. 1a with further reduced details;

FIG. 1d a cross-sectional view of the elements shown in FIG. 1b;

FIG. 2a a sectional view of the motor housing from FIGS. 1a, 1b and 1d;

FIG. 2b a perspective view of the motor housing from FIG. 2a;

FIG. 3 a perspective sectional view of the holding body of the arrangement shown in FIGS. 1a-1d;

FIG. 4 a perspective partially sectioned view of the motor from FIG. 1a;

FIG. 5 the view of the motor from FIG. 4 with reduced details;

FIG. 6a a perspective partially sectioned view of the rotor of the motor from FIG. 4;

FIG. 6b a perspective view of the rotor from FIG. 4;

FIG. 7 a perspective partially sectioned view of a motor in a further embodiment;

FIG. 8 a perspective partially sectioned view of an arrangement according to the first aspect of the invention in a second embodiment; and

FIG. 9 a schematic flow chart of a method according to the seventh aspect of the invention.

### DESCRIPTION OF THE EMBODIMENTS

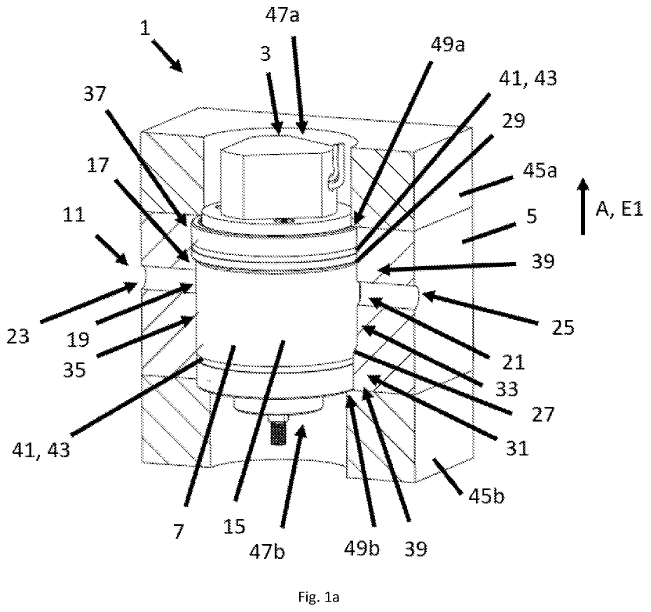

FIG. 1a shows a perspective partially sectioned view of an arrangement 1 according to the first aspect of the invention in a first embodiment.

The arrangement 1 comprises a motor 3 and a parallelepiped-shaped holding body 5 for holding the motor. The motor 3 in turn has a cylindrical housing 7. For its part, the holding body 5 has a cylindrical first recess 9 (shown in particular in FIG. 1c), which extends completely along a thickness range of the holding body 5. The motor 3 is partially received within the first recess 9.

FIG. 1b shows a perspective sectional view of the arrangement 1, whereby for the sake of clarity only the housing 7 of the motor 3 is shown. FIG. 1c shows a sectional view of the arrangement 1, whereby the motor 3 is not shown for the sake of clarity.

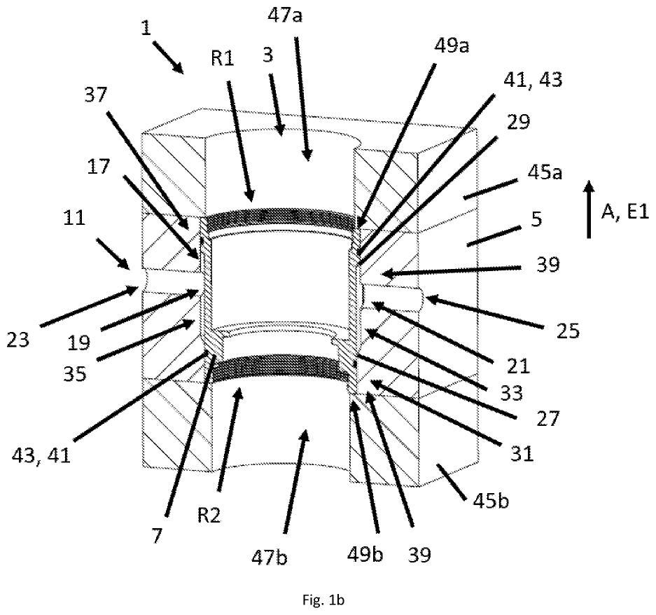

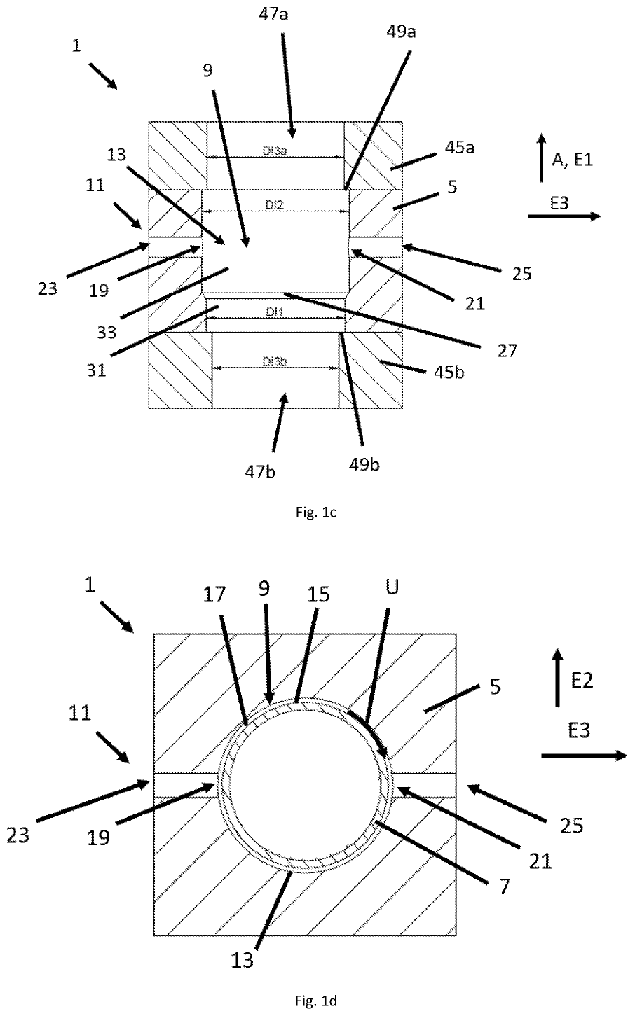

FIG. 2a shows a sectional view of the motor housing 7 in solo position. FIG. 2b shows a perspective view of the motor housing 7 of FIG. 2a. FIG. 3 shows a perspective sectional view of the holding body 5 of the arrangement 1 in solo position.

A thickness range of the main body 5 extends along a main extension direction E1 of the main body 5. The direction E1 as well as the other two main directions of extension of the main body 5 E2 and E3 all run perpendicular to each other (see the respective directional arrows in the figures).

The arrangement 1 also has a duct system 11, which is arranged at least partially within the holding body 5 and through which a coolant can flow. A specific surface 13 of the first recess 9 and a specific surface 15 of the motor 3 in the form of an outer surface of the motor housing 7 form a cooling section 17 of the duct system 11. The specific surfaces 13 and 15 are therefore surface areas of the first recess 9 and the motor housing 7 respectively.

The cooling section 17 is fluidically connected to the rest of the duct system 11 via two openings 19 and 21. The openings 19 and 21 are located at two locations within the first recess 9 and are diametrically opposed. In the present case, the openings 19 and 21 are arranged centrally between the two edges R1 and R2 of the first recess 9 along an axial direction A (see the respective directional arrow in the figures) running parallel to the centre axis of the first recess 9 (not explicitly shown in the figures) and to the main direction of extension E1.

The holding body 5 has a coolant inlet 23 and a coolant outlet 25 of the duct system 11, which can be connected to a coolant circuit not shown in detail.

FIG. 1d shows a cross-sectional view of the elements of the arrangement 1 shown in FIG. 1b within a plane extending perpendicularly to the centre axis of the first recess 9 and centrally through the openings 19 and 21. The ring-shaped cooling section 17 can be recognized particularly advantageously from FIG. 1d. In this cross-section, the specific surface 13 of the first recess 9 is arranged along a circumferential direction U (see the curved directional arrow in FIG. 1d) of the surface of the first recess 9 at a radial distance from the specific surface 15 of the motor 3 (i.e. a surface of the motor housing 7). The coolant can flow through the duct formed in this way and heat can thus be dissipated from the specific surface of the motor.

The motor 3 is thus arranged within the first recess 9 in such a way that a coolant entering the cooling section 17 at the inlet opening 19 flows around the specific surface 15 of the motor 3 (in this case a surface of the housing 7) and leaves the cooling section 17 again at the outlet opening 21 opposite the inlet opening 19. This allows the outer surface of the motor 3 to be cooled by dissipating heat from there.

The first recess 9 has a gradation 27 (see for example FIG. 1c) and the motor housing 7 has a gradation 29 (see for example FIG. 2a). The gradation 27 of the first recess 9 represents a transition between two recess sections 31 and 33 of the first recess 9 along the axial direction A. The gradation 29 of the housing 7 likewise represents a transition between two housing sections 35 and 37 along the axial direction A (see, for example, FIG. 1b).

The two recess sections 31 and 33 have different inner diameters DI1 and DI2. The two housing sections 35 and 37 have different outer diameters DA1 and DA2. The diameters DI1 and DA1 as well as the diameters DI2 and DA2 are identical. In this way, the cooling section 17 is laterally limited parallel and antiparallel to direction A to both edges of the recess 7 by the gradations 27 and 29.

Both end regions 39 of the motor housing 7 have a ring groove 41, within each of which an O-ring 43 (in FIG. 2b, the two O-rings 43 are also shown in addition to the motor housing 7) is arranged. As a result, the cooling section 17 is fluidically sealed towards the edges R1, R2 of the first recess 9.

The arrangement 1 has two parallelepiped-shaped locking bodies 45a and 45b, which are arranged on two opposite sides of the holding body 5. Each locking body 45a, 45b has a cylindrical second recess 47a and 47b, which penetrates the locking body 45a, 45b completely along a thickness range. The second recesses 47a and 47b are aligned coaxially with the first recess 9 and each has an inner diameter DI3a and DI3b which is in each case smaller than the inner diameter DI2 and DI1 of the edge R1 and R2 of the first recess 9 facing the respective second recess 47a, 47b. In other words, the inner diameter DI3a is selected to be smaller than the inner diameter DI2 and the inner diameter DI3b is selected to be smaller than the inner diameter DI1.

As a result, the locking bodies 45a and 45b each form a shoulder surface 49a and 49b on both sides of the holding body 5. The motor housing 7 is supported against the two shoulder surfaces 49a and 49b and is thereby fixed along the axial direction A.

The locking bodies 45a and 45b are connected to the holding body 5 in such a way that they can be detached again. As a result, the motor 3 can be easily removed from the first recess 9 by removing at least the locking body 45a from the holding body 5, for example for the purpose of maintenance or replacement.

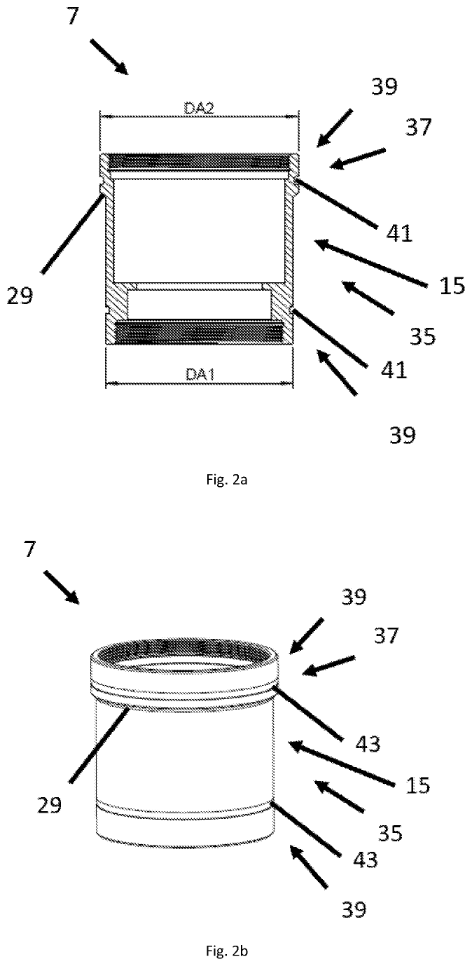

The motor 3 is in the form of a servomotor and is shown in greater detail in a partially sectioned perspective view in FIG. 4.

In addition to the housing 7, the motor 3 also has a rotor 51, which is positioned at a lower end of the motor 3 in FIG. 4 by means of a ball bearing 53 installed in the housing 7 and at an upper end of the motor 3 in FIG. 4 by means of a ball bearing 57 installed in a bearing cover 55. The ball bearings 53 and 57 are each designed as angular contact ball bearings.

At the lower end shown in FIG. 4, an outer collar 59 of the ball bearing 53 is supported against a bearing cover 61. The bearing cover 61 closes off the motor 3 on the underside and is fixed in place by a threaded ring 63 that can be screwed into the housing 7. At the opposite upper end, the bearing cover 55 closes off the motor 3 at the top. The bearing cover 55 is secured by a threaded ring 65 that can be screwed into the housing 7.

The rotor 51 is fixed and axially braced at the lower end by means of a threaded ring 67 to an inner collar 69 of the ball bearing 53 and at the upper end by means of a threaded ring 71 to an inner collar 73 of the ball bearing 57. Magnets 75 of the motor 3 are arranged on the side of the rotor 51. In addition, the rotor 51 has a spigot-shaped extension 77 at the upper end for accommodating a position sensor system 81 provided by the motor 3 and enclosed by a cover 79. Cable 85 of the position sensor system 81 and cable 87 of windings 89 of the motor 3 molded into the housing 7 can be routed to the outside through an opening 83 in the side of the cover 79.

Thanks to the threaded rings 63 and 65, no screws are required to fasten the bearing covers 55 and 61. The motor 3 is also particularly easy to design with a cylindrical housing 7, as the housing is no longer part of the fastening means.

The motor 3 has a spindle system 91 inserted inside the rotor 51 in the form of a linear spindle, which in turn has a spindle 93 and a spindle nut 95. A movement thread 97 is partially arranged on the outer circumference of the spindle 93 towards the upper end. The spindle 93 also has a fastening thread 99 at the lower end. The fastening thread 99 is adjoined in the axial direction by a flattened portion 101 which, in a manner known per se, enables the spindle 93 to be locked against co-rotation of the spindle 93 with the spindle nut 95. The spindle 93 is guided coaxially inside the motor 3 by a sliding bush 103 and sealed by a seal 105. The rotor 51 has a recess 107 on its inside, in which a tolerance sleeve 109 is arranged and which connects the spindle nut 95 to the rotor 51 in a force-locking manner via a clamping effect. During operation of the servomotor, the spindle nut 95 can be set in a rotational movement by rotating the rotor 51, and thereby the spindle 93 is linearly displaceable.

A stop buffer 111 is provided at the upper end of the rotor 51, which is attached to the rotor 51 by means of a screw 113. This prevents an unintentional stop in the event of a malfunction and thus prevents the spindle 93 from seizing. The front stop is provided by the sliding bush 103.

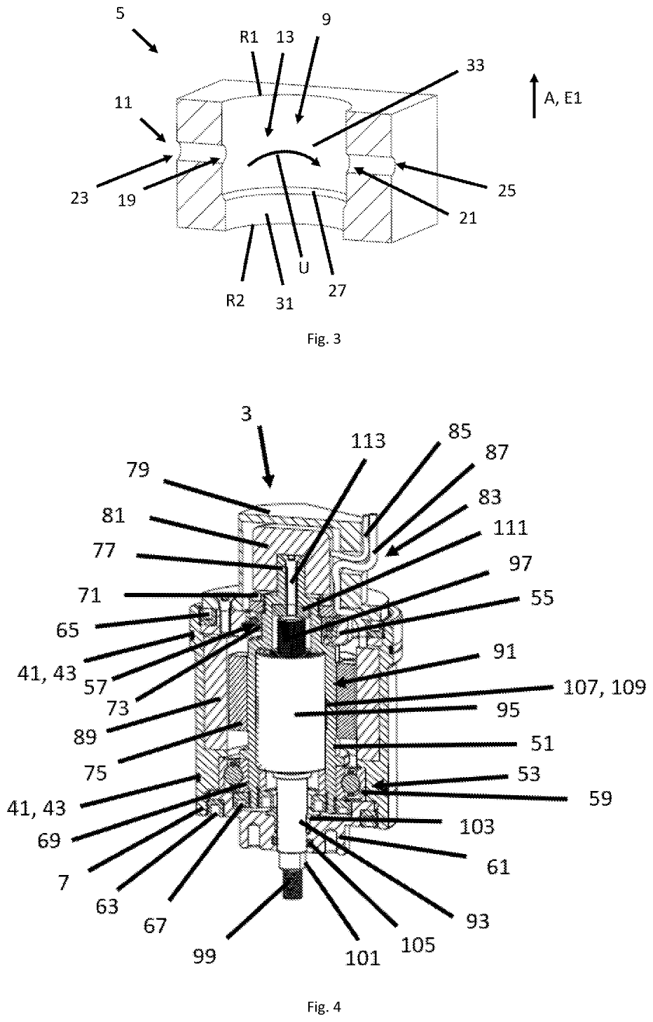

FIG. 5 shows the motor 3 without the spindle system 91 for a better overview. This allows a clear view of the rotor 51 and, in particular, its inside.

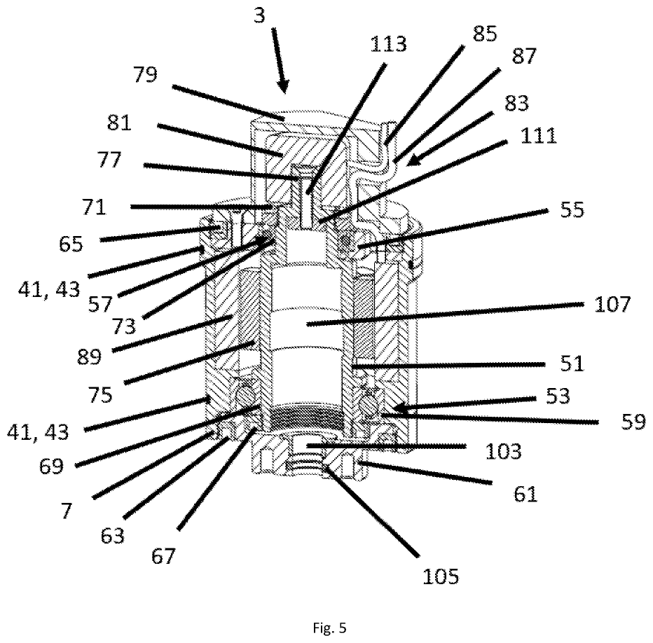

FIG. 6a shows the rotor 51 of the motor 3 in a partially sectioned perspective view. FIG. 6b shows the rotor 51 of the motor 3 in a perspective view. The rotor 51 has a plurality of flattenings 115 along a circumferential direction, to which the magnets 75 of the motor 3 are arranged, in particular glued. As can be seen particularly clearly in FIG. 6a, the rotor 51 is hollow on the inside, at least in some areas, and is designed as a sleeve-shaped part.

Due to the special design of the rotor 51 as a sleeve-shaped part, the spindle system 91 can be easily inserted into the interior of the rotor 51 and replaced in the event of damage or maintenance work. Different spindle systems can also be inserted into the rotor 51 in order to either build more cost-effective variants or to achieve higher thrust forces.

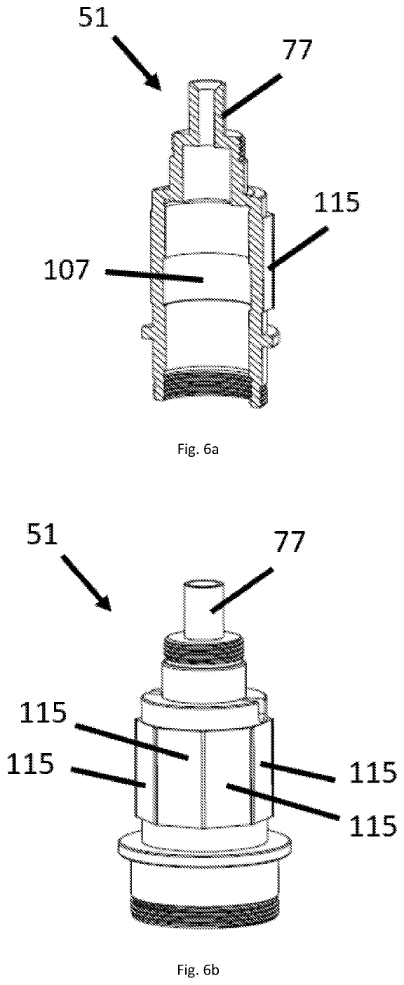

FIG. 7 shows a perspective, partially sectioned view of a motor 3 in a further embodiment. Here, the same features of the motor discussed in more detail with regard to FIGS. 4, 5, 6a and 6b are provided with the same reference symbols.

In the motor 3 shown in FIG. 7, the lower bearing cover 61 now has an external thread 117 in some areas and is screwed into the housing 7, thereby holding the bearing 53. The bearing cover 61 is therefore no longer held by a threaded ring. In addition, in the motor 3 shown in FIG. 7, the tolerance sleeve 109 is now arranged in a recess 119 provided on the outside of the spindle nut 95 (and no longer on the inside of the rotor 51).

The motor 3 (in either of the two embodiments described) can advantageously also be particularly preferred in a solo position, and can represent a motor according to the second aspect of the invention.

The holding body 5 can advantageously also be particularly preferred in the solo position and represent a holding body according to the third aspect of the invention.

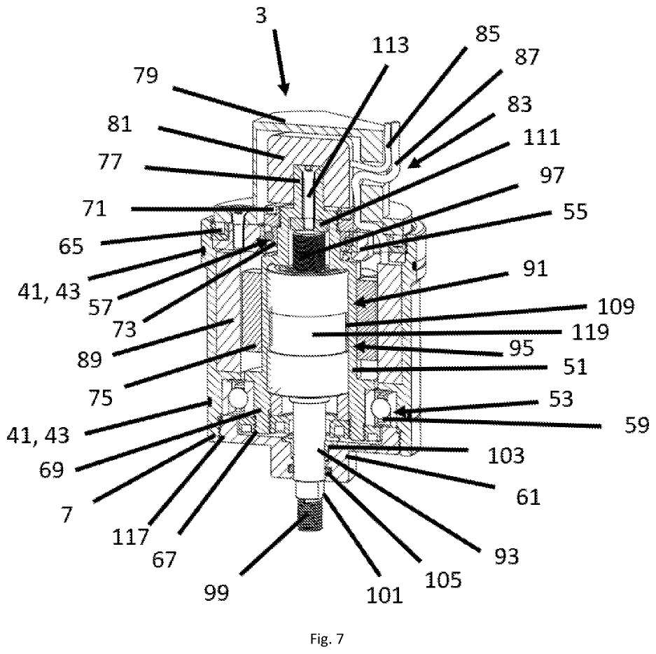

FIG. 8 shows a perspective partially sectioned view of an arrangement 1′ according to the first aspect of the invention in a second embodiment. Features which are the same as those of the arrangement 1 of the first embodiment are provided with the same, but simply cancelled, reference signs.

The arrangement 1′ has a plurality of motors 3′ which are at least partially received in a plurality of first recesses of a holding body 5′. The two locking bodies 45a′ and 45b′ correspondingly also each have a plurality of second recesses 47a′ and 47b′.

The plurality of cooling sections 17′ of the duct system 11′ formed by the specific surfaces 15′ of the motors 3′ (i.e. outer surfaces of the motor housing) and the first recesses are arranged fluidically in series with one another along a main flow direction S′ (see the directional arrow in FIG. 8) that is set when the arrangement 1′ is used. In the illustration shown in FIG. 8, for example, the coolant can flow through the arrangement 1′ “from top to bottom” by guiding fluid from the coolant inlet 23′ to the coolant outlet 25′.

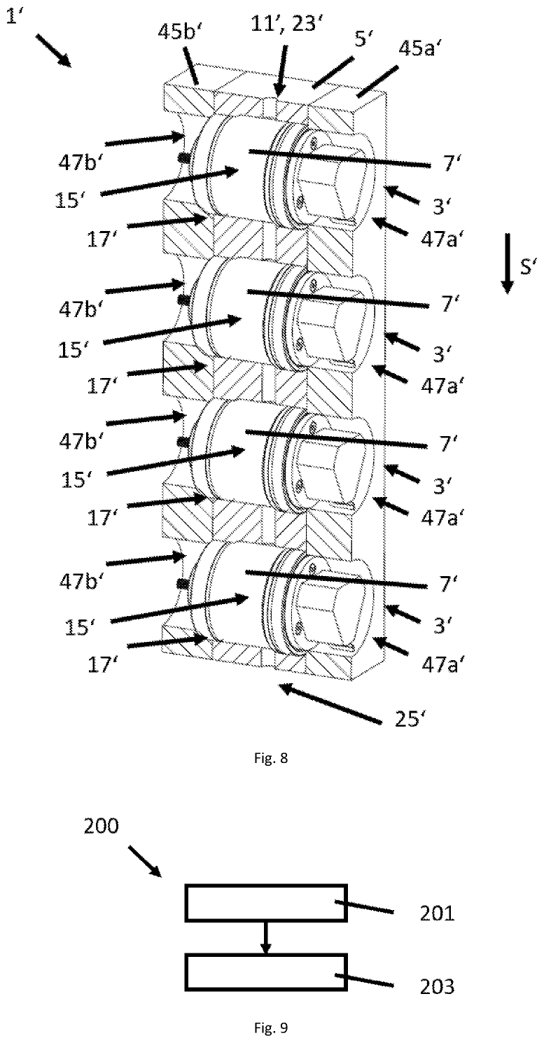

FIG. 9 shows a schematic flow chart of a method 200 for cooling a motor.

If a motor, such as the motor 3 of the arrangement 1, or several motors, such as the motors 3′ of the arrangement 1′, for example of a moulding device, are to be cooled, an arrangement according to the first aspect of the invention, such as an arrangement 1 or an arrangement 1′, can be provided for this purpose in 201. In 203, a coolant, such as water, is at least temporarily passed through the duct system (such as duct system 11 or 11′) of the arrangement from the coolant inlet (such as coolant inlet 23 or 23′) to the coolant outlet (such as coolant outlet 25 or 25′).

Particularly advantageous embodiments of a motor according to the second aspect of the invention are shown below as examples 1 to 44.

Example 1: Motor for a moulding device, wherein the motor comprises at least one rotor and a spindle system, wherein the spindle system is inserted or insertable, in particular at least partially, within the rotor.

Example 2: Motor according to one of the preceding examples, wherein the motor is an electric motor, such as a servomotor.

Example 3: Motor according to one of the preceding examples, wherein the motor comprises a housing which is at least in some areas cylindrical in shape.

Example 4: Motor according to one of the preceding examples, wherein the motor comprises at least one rotor.

Example 5: Motor according to one of the preceding examples, wherein the motor comprises one or more than one, in particular two, ball bearings, in particular angular contact ball bearings.

Example 6: Motor according to example 5, wherein the rotor is positioned by at least two of the ball bearings, in particular within the motor, wherein a first ball bearing of the at least two ball bearings is installed in the housing and a second ball bearing of the at least two ball bearings is installed in a first bearing cover of the motor.

Example 7: Motor according to one of examples 5 to 6, wherein an outer collar of the first ball bearing is supported against a second bearing cover of the motor.

Example 8: Motor according to example 7, wherein the second bearing cover closes off the motor on one side, in particular on its underside, and/or is fixed by a threaded ring that can be screwed into the motor housing.

Example 9: Motor according to one of examples 6 to 8, wherein the first bearing cover closes off the motor on one side, in particular on its upper side, and/or is fixed by a threaded ring that can be screwed into the motor housing.

Example 10: Motor according to one of the examples 8 to 9, wherein no screws are required for fastening the first and/or second bearing cover due to the threaded rings.

Example 11: Motor according to one of the preceding examples, wherein the rotor, in particular at the lower end, is fixed and axially braced by means of a threaded ring to an inner collar of the first ball bearing and/or, in particular at the upper end, by means of a threaded ring to an inner collar of the second ball bearing.

Example 12: Motor according to one of the preceding examples, wherein the rotor, in particular along a circumferential direction, comprises a plurality of, in particular lateral, flattenings, wherein magnets of the motor are arranged or can be laid out on the flattenings, in particular the motor comprises magnets which are arranged, in particular glued, on the flattenings.

Example 13: Motor according to one of the preceding examples, wherein the rotor, in particular at the upper end, comprises a spigot-shaped extension for accommodating a position sensor system provided by the motor and preferably enclosed by a cover, wherein preferably (i) the motor comprises such a position sensor system and this is accommodated by the spigot-shaped extension and/or (ii) the cover comprises a lateral opening through which preferably cables of the position sensor system and/or cables of windings of the motor molded into the housing can be guided to the outside.

Example 14: Motor according to one of the preceding examples, wherein the motor comprises a spindle system, in particular one which is inserted or can be inserted inside the rotor.

Example 15: Motor according to one of the preceding examples, wherein the spindle system is in the form of a linear spindle.

Example 16: Motor according to one of the preceding examples, wherein the spindle system comprises a spindle and a spindle nut.

Example 17: Motor according to example 16, wherein a movement thread is arranged on the outer circumference of the spindle at least in some areas, in particular partially towards the upper end.

Example 18: Motor according to one of examples 16 to 17, wherein the spindle, in particular at the lower end, comprises a fastening thread, wherein preferably a flattened portion adjoins the fastening thread in axial direction, in particular for locking the spindle to prevent the spindle from rotating together with the spindle nut.

Example 19: Motor according to example 18, wherein the locking mechanism is provided on the component to be moved, such as a closing needle of a hot duct system.

Example 20: Motor according to one of the preceding examples, wherein the component to be moved by the motor is a closing needle of a hot duct system.

Example 21: Motor according to one of the examples 16 to 20, wherein the spindle is guided coaxially within the motor by a sliding bush and/or is sealed by a seal.

Example 22: Motor according to one of the preceding examples, wherein the rotor comprises at least one cavity for receiving the spindle system, such as a linear spindle system, or parts thereof, such as at least the spindle nut, and/or the rotor is at least in some areas designed hollow, designed as a sleeve-shaped part and/or designed as a hollow shaft.

Example 23: Motor according to example 22, wherein due to the special design of the rotor as a sleeve-shaped part the spindle system, in particular in the form of a linear spindle, can be inserted into the inside of the rotor, in particular at least partially, and/or can be replaced in the event of damage or maintenance work, and/or different spindle systems can be inserted into the rotor.

Example 24: Motor according to one of the examples 16 to 23, wherein the rotor comprises a recess on its inside in which a tolerance sleeve is arranged and which connects the spindle nut to the rotor in a force-locking manner via a clamping effect.

Example 25: Motor according to one of the examples 16 to 24, wherein during operation of the motor, in particular the servomotor, the spindle nut can be set into a rotative movement, in particular in phase, by rotation of the rotor and thereby the spindle can be displaced linearly, wherein preferably the spindle nut and the rotor are connected to each other in a non-rotatable manner for this purpose.

Example 26: Motor according to one of the examples 16 to 25, wherein the motor, in particular the servomotor, is set up so that during operation of the motor the spindle nut performs a rotational movement due to rotation of the rotor and thereby the spindle is linearly displaceable.

Example 27: Motor according to one of the preceding examples, wherein a stop buffer is provided at the upper end of the rotor, in particular within the motor, which is preferably fastened to the rotor by means of a screw.

Example 28: Motor according to one of the preceding examples, wherein the rotor is preferably designed as a sleeve-shaped part, in particular for at least partially receiving the linear spindle and/or the spindle nut.

Example 29: Motor according to one of the examples 7 to 28, wherein the second bearing cover comprises an external thread at least in some areas and/or can be screwed into the housing and/or wherein the second bearing cover holds the first ball bearing.

Example 30: Motor according to one of the preceding examples, wherein the spindle nut comprises a recess on an outer side in which a tolerance sleeve is arranged.

Example 31: Motor according to one of the preceding examples, wherein the motor comprises at least one, preferably at least in some areas and/or at least sectionally cylindrical, housing, which preferably comprises at least one gradation and/or at two axial end regions in each case a circumferential groove with an O-ring arranged therein in each case.

Example 32: Motor according to one of the preceding examples, wherein the motor is suitable, adapted and/or used for use in a motor arrangement for a moulding device, wherein the motor arrangement comprises at least one motor and at least one holding body for holding the motor, wherein the holding body comprises at least one first recess within which the motor is at least partially received; and wherein the arrangement comprises at least one duct system, through which a coolant can flow and which is at least partially arranged within the holding body, for dissipating heat from the motor, wherein the duct system comprises at least one cooling section which is at least in some areas formed by at least one specific surface of the motor and at least one specific surface of the first recess.

Example 33: Motor according to one of the preceding examples, wherein the motor is an electric motor, such as a servomotor, in particular in the form of a linear actuator for generating translational movements.

Example 34: Motor according to one of the preceding examples, wherein the motor is a servomotor and the servomotor is of the brushless rotary type and/or comprises an encoder or a resolver as a position encoder system.

Example 35: Motor according to one of the preceding examples, wherein the motor is a servomotor and the servomotor is designed as a linear actuator for generating translatory movements and/or the servomotor is designed for generating rotatory movements.

Example 36: Motor according to one of the preceding examples, wherein the axial extension of the motor is 30 mm or more, 200 mm or less and/or between 30 mm and 200 mm.

Example 37: Motor according to one of the preceding examples, wherein the motor comprises at least one bearing cover for closing off at least one end of the motor, wherein preferably (a) the bearing cover comprises at least one external thread at least in some areas and the bearing cover is screwed or can be screwed into the motor housing by means of the external thread and/or (b) the motor furthermore comprises at least one threaded ring for fastening the bearing cover of the motor to the motor housing and/or comprises at least one spindle system for converting a rotary movement into a linear movement of the motor.

Example 38: Motor according to one of the preceding examples, wherein the respective bearing cover is fastened to the motor housing with the respective threaded ring.

Example 39: Motor according to one of the preceding examples, wherein the motor comprises a spindle system installed within the motor for converting a rotary movement into a linear movement, in particular for carrying out translatory movements with the motor.

Example 40: Motor according to one of the preceding examples, wherein the motor comprises two bearing covers for closing off both ends of the motor, preferably each of the bearing covers being optionally provided with an external thread or being fastened to the motor by a threaded ring.

Example 41: Motor according to one of the preceding examples, wherein the spindle system comprises a spindle nut and a spindle.

Example 42: Motor according to any of the preceding examples, wherein the rotor of the motor is positioned at its end portions within the housing of the motor by means of at least two ball bearings, and wherein preferably
one of the ball bearings, in particular an outer collar of the ball bearing, is supported against one of the bearing covers of the motor, which bearing cover is preferably (a) fixed by the threaded ring screwed into the housing, (b) screwed into the motor housing and/or (c) closes off the motor on the underside,
and/or
(ii) the other ball bearing, in particular an outer collar of the other ball bearing, is supported against another of the bearing covers of the motor, which other bearing cover is preferably (a) fixed by the threaded ring screwed into the housing, (b) screwed into the motor housing and/or (c) closes off the motor at the top.

Example 43: Motor according to one of the preceding examples, wherein the bearing cover is at least in some areas ring-shaped.

Example 44: Motor according to one of the preceding examples, wherein the ball bearings are designed as angular contact ball bearings, in particular in order to absorb axial forces occurring, preferably in connection with the spindle system.

The features disclosed in the preceding description, in the drawings and in the claims can be essential to the invention in its various embodiments, both individually and in any combination.

### REFERENCE SIGNS LIST

1, 1′ Arrangement
3, 3′ Motor
5, 5′ Holding body
7 Housing
9, 9′ Recess
11, 11′ Duct system
13 Specific surface
15, 15′ Specific surface
17, 17′ Cooling section
19 Opening
21 Opening
23, 23′ Coolant inlet
25, 25′ Coolant outlet
27 Gradation
29 Gradation
31 Recessed section
33 Recessed section
35 Housing section
37 Housing section
39 End region
41 Ring groove
43 O-ring
45a, 45a′ Locking body
45b, 45b′ Locking body
47a, 47a′ Second recess
47a, 47b′ Second recess
49a Shoulder surface
49b Shoulder surface
51 Rotor
53 Ball bearing
55 Bearing cover
57 Ball bearing
59 Collar
61 Bearing cover
63 Threaded ring
65 Threaded ring
67 Threaded ring
69 Inner collar
71 Threaded ring
73 Inner collar
75 Magnets
77 Extension
79 Cover
81 Position sensor system
83 Opening
85 Cable
87 Cable
89 Windings
91 Spindle system
93 Spindle
95 Spindle nut
97 Movement thread
99 Fastening thread
101 Flattening
103 Sliding bush
105 Seal
107 Insertion
109 Tolerance sleeve
111 Buffer stop
113 Screw
115 Flattening
117 External thread
119 Insertion
200 Procedure
201 Providing an arrangement
203 Passing a coolant through a duct system of the arrangement
A Axial direction
DA1 Outer diameter
DA2 Outer diameter
DI1 Inner diameter
DI2 Inner diameter
DI3a Inner diameter
DI3b Inner diameter
E1 Main extension direction
E2 Main extension direction
E3 Main extension direction
R1 Edge
R2 Edge
S′ Main flow direction
U Circumferential direction

1. A motor arrangement for a moulding device, the motor arrangement comprising:
at least one motor;
at least one holding body for holding the at least one motor, the at least one holding body comprising at least one first recess within which the at least one motor is at least partially received: and
at least one duct system, through which a coolant is configured to flow and which is at least partially arranged within the at least one holding body, for dissipating heat from the at least one motor,
wherein the at least one duct system comprises at least one cooling section which is formed at least in some areas by at least one specific surface of the at least one motor and at least one specific surface of the first recess.

2. The motor arrangement according to claim 1, wherein the at least one holding body is parallelepiped-shaped, in particular plate-shaped.

3. The motor arrangement according to claim 1, wherein the first recess is cylindrical at least in some areas, and/or completely penetrates the at least one holding body along a main direction of extension, in particular a thickness range, of the at least one holding body.

4. The motor arrangement according to claim 1, wherein the specific surface of the at least one motor is strip-shaped at least in some areas, and/or is at least one outer surface area of a housing of the at least one motor.

5. The motor arrangement according to claim 1, wherein the duct system is formed at least in sections by cavities extending within the at least one holding body.

6. The motor arrangement according to claim 1, wherein the cooling section is fluidly connected to the remaining duct system via at least two openings, in particular at two locations within the first recess and/or at two diametrically opposed locations within the first recess.

7. The motor arrangement according to claim 1, wherein the cooling section, within a cross-sectional plane, extending in particular perpendicularly to the centre axis of the first recess and/or perpendicularly to a motor axis, is ring-shaped at least in some areas.

8. The motor arrangement according to claim 1, wherein the specific surface of the first recess is strip-shaped at least in some areas, is at least one surface area of the first recess, and/or is arranged at a distance from the specific surface of the at least one motor at least in some areas and/or along at least one circumferential direction of the surface of the first recess.

9. The motor arrangement according to claim 1, wherein the specific surface of the first recess and the specific surface of the at least one motor are designed and/or arranged relative to each other in such a way that they form, at least in some areas, a duct as at least one part of the cooling section, through which duct the coolant can flow.

10. The motor arrangement according to claim 1, wherein the first recess comprises at least two gradations, by which the cooling section is at least in some areas limited along the two axial directions of the first recess.

11. The motor arrangement according to claim 1, wherein the motor housing comprises at least two gradations, by which the cooling section is at least in some areas limited along the two axial directions of the first recess.

12. The motor arrangement according to claim 1, wherein the first recess comprises at least one gradation and the motor housing comprises at least one gradation, by which gradations the cooling section is at least in some areas limited along the two axial directions of the first recess.

13. The motor arrangement according to claim 1, wherein at least one sealing element for sealing the cooling section towards the outside, in particular towards one or both outer edges of the first recess, is or are arranged inside the first recess.

14. (canceled)

15. The motor Arrangement according to claim 1, wherein the at least one motor, in particular the housing of the at least one motor, is supported on at least one support element of the arrangement to limit the displaceability of the motor along an axial direction within the first recess.

16. The motor arrangement according to claim 15, wherein:
(i) the support element is provided in the form of a shoulder surface of at least one locking body of the arrangement, the at least one locking body is arranged laterally at the at least one holding body, wherein the locking body comprises at least one cylindrical second recess, penetrating the locking body along a main direction of extension, in particular a thickness range, of the locking body, wherein the first recess and the second recess are aligned coaxially to one another, and wherein the facing outer edges of the first and second recess have diameters, and the diameter of the edge of the second recess is smaller than the diameter of the edge of the first recess, and the shoulder surface is formed thereby.
(ii) the at least one motor, in particular the housing of the at least one motor, is supported on at least two support elements of the arrangement for fixing the axial position of the at least one motor along an axial direction within the first recess, wherein both support elements are provided in the form of shoulder surfaces of at least two locking bodies of the arrangement arranged on two opposite sides of the at least one holding body at the at least one holding body with second recesses adapted to the respective diameters of the outer edges of the first recess.
(iii) the at least one holding body is connected to at least one or exactly one of the locking bodies in such a way so that the at least one holding body is configured to be detached again without being destroyed, and/or
(iv) the at least one holding body and/or the at least one locking body comprises or consists of metal, in particular aluminum, steel, in particular stainless steel, brass and/or an alloy and/or powder-metallurgical combinations of the aforementioned materials.

17-19. (canceled)

20. The motor arrangement according to claim 1, wherein:
(A) the at least one motor is an electric motor, in the form of a linear actuator for generating translatory movements,
(B) the at least one motor comprises at least one rotor and a spindle system inserted or insertable within the rotor, wherein (i) the spindle system comprises a spindle and a spindle nut, and/or (ii) during operation of the motor, in particular of the servomotor, the spindle nut is configured to be set into a rotative movement, in particular in phase, by a rotation of the rotor and thereby the spindle is linearly displaceable, wherein the spindle nut and the rotor are connected to each other in a non-rotatable manner for this purpose, and/or
(C) the at least one motor comprises at least one bearing cover for closing off at least one end of the at least one motor, wherein (a) the bearing cover comprises at least one external thread at least in some areas and the bearing cover is screwed or can be screwed into the motor housing by means of the external thread. and/or (b) the at least one motor furthermore comprises at least one threaded ring for fastening the bearing cover of the at least one motor to the motor housing and/or comprises at least one spindle system for converting a rotary movement into a linear movement of the at least one motor.

21-22. (canceled)

23. The motor arrangement according to claim 1, wherein a rotor of the at least one motor is positioned at its end portions within the housing of the at least one motor by at least two ball bearings, and wherein:
the one ball bearing, in particular an outer collar of the ball bearing, is supported against one of the bearing covers of the at least one motor, which bearing cover is (a) fixed by the threaded ring screwed into the housing, (b) screwed into the motor housing. and/or (c) closes off the at least one motor on the underside, and/or
the other ball bearing, in particular an outer collar of the other ball bearing, is supported against another of the bearing covers of the at least one motor, which other bearing cover is (a) fixed by the threaded ring screwed into the housing, (b) screwed into the motor housing, and/or (c) closes off the at least one motor at the top.

24. The motor arrangement according to claim 1, wherein:
(i) the arrangement comprises a plurality of motors, comprising the at least one motor, and the at least one holding body comprises a plurality of first recesses with the motors at least partially received therein, and wherein the duct system comprises at least two cooling sections formed by the specific surfaces of the first recesses and motors, which cooling sections are arranged at least partially fluidically in series or parallel to one another,
(ii) the arrangement comprises the plurality of motors and the at least one holding body comprises a plurality of first recesses with the motors at least partially received therein, and wherein the arrangement comprises at least two separate duct systems each with at least one of the cooling sections formed by the specific surfaces of the first recesses and motors, and/or
(iii) the coolant comprises or consists of a fluid, in particular water, air, oil, at least one liquefied gas, at least one alcohol, and/or a mixture of the aforementioned substances.

25-27. (canceled)

28. An electric motor for a moulding device of a motor arrangement, the motor arrangement comprising at least one holding body for holding the motor, the holding body comprising at least one first recess within which the motor is at least partially receivable, and the motor arrangement further comprising at least one duct system, through which a coolant can flow and which is at least partially arranged within the holding body, for dissipating heat from the motor, the duct system comprising at least one cooling section which is formed at least in some areas by at least one specific surface of the motor and at least one specific surface of the first recess, the motor comprising:
at least one, preferably at least in some areas and/or at least sectionally cylindrical, housing, which preferably comprises at least one gradation and/or at two axial end regions in each case a circumferential groove with an O-ring arranged therein in each case.

29-34. (canceled)

35. A method for cooling the at least one motor of the motor arrangement for moulding device according to claim 1, the method comprising:
providing the motor arrangement; and
at least temporarily passing the coolant, comprising or consisting of a fluid, in particular water, air, oil, at least one liquefied gas, at least one alcohol, and/or a mixture of the aforementioned substances, through the at least one duct system of the arrangement, in particular from a coolant inlet to a coolant outlet.

36-51. (canceled)
